(19) United States
(12) Patent Application Publication
(10) Pub. No.: US 2008/0229109 A1
(43) Pub. Date: Sep. 18, 2008

(54) HUMAN-RECOGNIZABLE CRYPTOGRAPHIC KEYS

(76) Inventors: Alexander Gantman, Poway, CA (US); Gregory G. Rose, San Diego, CA (US)

Correspondence Address: Amin, Turocy & Calvin LLP, 1900 E. 9th Street, 24th Floor, National City Center, Cleveland, OH, 44114, US

(21) Appl. No.: 11/685,110

(22) Filed: Mar. 12, 2007

(51) Int. Cl. H04L 9/00

(52) U.S. Cl. 713/176

(57) ABSTRACT

A visual authentication scheme for websites is provided that binds an image to a website so that a user can by visually authenticate whether he/she is viewing an intended/trusted website. An authentication or cryptographic key (associated with a web page) is rendered as a unique key-identifying image or unique sequence of images. This key-identifying image(s) is then displayed to the user. The user associates this key-identifying image with the originator or source of the web page so that the user can easily recognize the originator by glancing at the key-identifying image. The association between the key-identifying image and the cryptographic/authentication key (and thereby the source of the web page) can be achieved similarly to brand awareness.

### BACKGROUND

1. Field

Various examples pertain to authentication mechanisms and particularly to ways of allowing users to visually and/or audibly authenticate or distinguish a valid electronic message or web page from an invalid (pirated) electronic message or web page.

2. Background

Many web applications provide for transmission of personal and/or confidential user information over the internet. For example, in performing online banking users typically enters an account number and/or password(s), and in performing online transactions users provide credit card information. To safeguard the security of this personal and/or confidential information, computers and applications typically authenticate each other using cryptography. For example, an exchange of cryptographic keys may be used to establish a secure link between a user's web browser and a website and/or a “middleman” may certify the authenticity of the website and web pages therein. However, cryptographic operations are impossible for humans to compute. Luckily, the computation can be left up to the user's computer. However, one problem is binding the cryptographic key of the sender to the sender's identity.

Additionally, conventional cryptographic and/or authentication certificate mechanisms are not effective where a pirate website mimics an authentic website. An online activity called phishing attempts to fraudulently acquire personal or financial information from web users by masquerading as a trustworthy website or web page. For instances, a pirated web page that appears to be from a trustworthy/authentic website may be setup to lure web users to provide personal and/or confidential information. These pirate websites typically exploit misspellings of legitimate domain names and/or otherwise mimic the appearance of legitimate/trustworthy websites to cause web users to provide their personal information (e.g., passwords, account numbers, etc.). These pirate websites may obtain cryptographic keys that can be used by web browsers to establish a secure link for transactions. Thus, current security mechanisms are ineffective in protecting users from pirate websites. A system is needed to allow users to ascertain whether they are connected to a legitimate website or a pirate website.

### SUMMARY

A method is provided for visually authenticating an originator of a received electronic message on a user terminal. An electronic message authenticated by the originator of the electronic message using a cryptographic key is obtained. A key-identifying image is obtained based on the cryptographic key. The key-identifying image is displayed on the user terminal to enable a user to identify the cryptographic key used by the originator to authenticate the electronic message. The key-identifying image may be a function of the cryptographic key and/or may be generated by a collision-resistant algorithm. The electronic message may be requested from a host and the electronic message may be displayed along with the key-identifying image. The key-identifying image may be obtained based on the cryptographic key by (1) generating the key-identifying image based on an image generation algorithm stored at the user terminal and/or (2) selecting one or more images from a plurality of key-identifying images stored at the user terminal, the one or more images forming the key-identifying image that uniquely identifies the cryptographic key used by the originator to authenticate the electronic message. The cryptographic key may securely identify the originator of the electronic message. The cryptographic key may be selected from a plurality of keys, each key associated with a different key-identifying image. Alternatively, the cryptographic key may be associated with a plurality of key-identifying images.

The key-identifying image that is displayed may be selected based on at least one of (a) an indication sent by the message originator, (b) a preference stored at the user terminal, or (c) user actions. Obtaining the key-identifying image based on the one or more keys includes using a collision-resistant function to generate the key-identifying image, wherein the collision-resistant function inhibits generating the same key-identifying image using other keys.

A user terminal is also provided comprising: (a) a communication interface to couple the user terminal to a network; (b) a display device; and/or (c) a processing device coupled to the communication interface and display device. The processing device may be configured to (1) obtain an electronic message authenticated by an originator of the message using a cryptographic key; (2) obtain a key-identifying image based on the cryptographic key; and/or (3) display the key-identifying image on the display device to enable a user to visually authenticate the cryptographic key used by the originator to authenticate the received electronic message. A storage device may be coupled to the processing device, the storage device for storing a plurality of key-identifying images, wherein the key-identifying image is selected from one or more of the plurality of the stored key-identifying images. The one or more key-identifying images may form the key-identifying image that uniquely identifies the cryptographic key used by the originator to authenticate the electronic message. The cryptographic key securely identifies the originator of the electronic message. The cryptographic key may be selected from a plurality of keys, each key associated with a different key-identifying image. Alternatively, the cryptographic key is associated with a plurality of key-identifying images. The key-identifying image that is displayed may be selected based on at least one of (a) an indication sent by the message originator, (b) a preference stored at the user terminal, or (c) user actions. The processing unit may be further configured to (1) generate a set of audible tones uniquely associated with the cryptographic key, and/or (2) generate the key-identifying image using a collision-resistant function that inhibits generating the same key-identifying image using other keys.

Consequently, a terminal device is provided comprising: (a) means for obtaining an electronic message authenticated by the originator of the message using a cryptographic key; (b) means for obtaining a key-identifying image based on the cryptographic key; (c) means for presenting the key-identifying image to enable a user to visually authenticate the cryptographic key used by the originator to authenticate the received electronic message; (d) means for requesting the electronic message from the originator; (e) means for displaying the electronic message along with the key-identifying image; (f) means for selecting one or more images from a plurality of key-identifying images stored at the terminal device, the one or more images forming the key-identifying image that uniquely identifies the cryptographic key used by the originator to authenticate the electronic message; and/or (g) means for generating the key-identifying image based on a collision-resistant image generation algorithm stored at the terminal device.

A machine-readable medium is also provided having one or more instructions for allowing a user to visually authenticate an originator of a received electronic message on a terminal. The one or more instructions may cause a processor to: (a) obtain an electronic message authenticated by the originator of the message using a cryptographic key; (b) obtain a key-identifying image based on the cryptographic key; (c) display the key-identifying image on the terminal to enable a user to visually authenticate the cryptographic key used by the originator to authenticate the electronic message; (d) display the electronic message along with the key-identifying image; (e) store a plurality of key-identifying images in the terminal; and/or (f) select one or more images from the plurality of key-identifying images, the one or more images forming the key-identifying image that uniquely identifies the cryptographic key used by the originator to authenticate the electronic message.

Additionally, a processing device is provided comprising a processing unit configured to (a) obtain an electronic message authenticated by the originator of the electronic message using a cryptographic key; (b) select one or more images from the plurality of key-identifying images, the one or more images forming a key-identifying image that uniquely identifies the cryptographic key used by the originator to authenticate the electronic message; (c) cause the key-identifying image to be displayed to enable a user to visually authenticate the cryptographic key used by the originator to authenticate the electronic message; and/or (d) select the key-identifying image based on at least one of (1) an indication sent by the message originator, (2) a preference stored at the user terminal, or (3) user actions.

A method for facilitating visual authentication of a transmitted electronic message is also provided. A cryptographic key that securely identifies an originator of the electronic message is obtained. The electronic message is authenticated with the cryptographic key. The electronic message is sent to a user terminal along with the cryptographic key. An indication of the cryptographic key to use in rendering a key-identifying image at the user terminal is also sent. The cryptographic key may include one or more certificates associated with the originator of the electronic message. The cryptographic key may also be sent to the user terminal. The cryptographic key may be selected from a plurality of certificates associated with the originator of the electronic message.

A host device is also provided comprising: (a) a communication interface to couple the host device to a network and receive a request for an electronic message from a requesting user terminal; and (b) a processing device coupled to the communication interface. The processing device may be configured to (1) obtain a cryptographic key that securely identifies an originator of the electronic message; and/or (2) authenticate the electronic message with the cryptographic key; (3) send the electronic message to a user terminal along with the cryptographic key; (4) send an indication of the cryptographic key to use in rendering a key-identifying image at the user terminal; and/or (5) send an indication of one or more key-identifying images to render at the user terminal. The cryptographic key may be selected from a plurality of keys, each key associated with a different key-identifying image. The cryptographic key may be associated with a plurality of images that makeup the key-identifying image.

Consequently, a server device comprising: (a) means for receiving a request for an electronic message from a requesting user terminal; (b) means for obtaining a cryptographic key that securely identifies an originator of the electronic message; (c) means for authenticating the electronic message with the cryptographic key; (d) means for sending the electronic message to a user terminal along with the cryptographic key; and/or (e) means for indicating the cryptographic key to use in rendering a key-identifying image at the user terminal. The cryptographic key may include one or more certificates associated with the originator of the electronic message.

A machine-readable medium is also provided having one or more instructions for facilitating visual authentication of a transmitted electronic message, which when executed by a processor causes the processor to: (a) obtain a cryptographic key that securely identifies an originator of the electronic message; (b) send the electronic message to a user terminal along with the cryptographic key; (c) send an indication of one of the cryptographic key to use in rendering a key-identifying image at the user terminal; and/or (d) authenticate the electronic message with the cryptographic key.

A processing device is also provided comprising a processing unit configured to (a) obtain a cryptographic key that securely identifies an originator of the electronic message; (b) authenticate the electronic message with the cryptographic key; (c) send an indication of the cryptographic key to use in rendering a key-identifying image at the user terminal; and/or (d) send the electronic message to a user terminal along with the cryptographic key.

### BRIEF DESCRIPTION OF THE DRAWINGS

FIG. 1 illustrates a communication network in which a visual authentication scheme may be implemented.

FIG. 2 illustrates an example of a visual authentication scheme that may operate on the communication network of FIG. 1.

FIG. 3 illustrates one example of a user terminal that may be configured to provide a user with visual authentication of a displayed website's owner.

FIG. 4 illustrates a method that may operate on the user terminal to enable the user to visually authenticate a sender of a received website.

FIG. 5 illustrates application components operational on a user terminal that enable the user to visually authenticate a sender of a received website.

FIG. 6 illustrates how a cryptographic key may include a hierarchy of keys.

FIG. 7 illustrates a web server or host device configured to provide web pages with cryptographic keys to user terminals to facilitate visual authentication of the web pages at the user terminals.

FIG. 8 illustrates a method operational on a web server or host device that facilitates visual authentication of the sender of web pages displayed on user terminals.

### DETAILED DESCRIPTION

In the following description, specific details are given to provide a thorough understanding of aspects of the invention. However, it will be understood by one of ordinary skill in the art that these aspects of the invention may be practiced without these specific details. For example, circuit details may not be shown in block diagrams in order to not obscure the examples or configurations illustrated therein.

Also, it is noted that the examples may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels, and various other mediums capable of storing, containing, or carrying instruction(s) and/or data.

Furthermore, configurations may be implemented by hardware, software, firmware, middleware, microcode, or a combination thereof. When implemented in software, firmware, middleware, or microcode, the program code or code segments to perform the necessary tasks may be stored in a machine-readable medium such as a storage medium or other storage means. A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others.

In the following description, certain terminology is used to describe certain features of one or more examples of the invention. The term “web site” refers to one or more associated web pages. The terms “key” (e.g., cryptographic key, authentication key) refers to a certificate, identifier, cryptograph, or other types of numeric, alpha-numeric, or symbols that uniquely identify a web page sender. The term “image” (e.g., key-identifying image, authentication image) refers to a black and white, color, and/or grayscale visual representation including graphics, icons, hieroglyphs, alpha-numeric objects, and/or pictures, etc., as well as audio.

One feature provides visual authentication for websites by binding an image to a website so that a user can by visually authenticate whether he/she is connected to an intended/trusted website. As used hereinafter, an “image” includes any visual representation that can be presented to a user. A hash of a cryptographic/authentication key (associated with a web page) is rendered as a unique key-identifying image or unique sequence of images. This unique key-identifying image(s) is then displayed by the application to the user. The user associates this key-identifying image with the originator or source of the web page so that the user can easily recognize the source by glancing at the key-identifying image. The association between the key-identifying image and the cryptographic/authentication key (and thereby the web page owner's identity) can be achieved similarly to brand awareness.

### General Scheme for User Authentication of Website

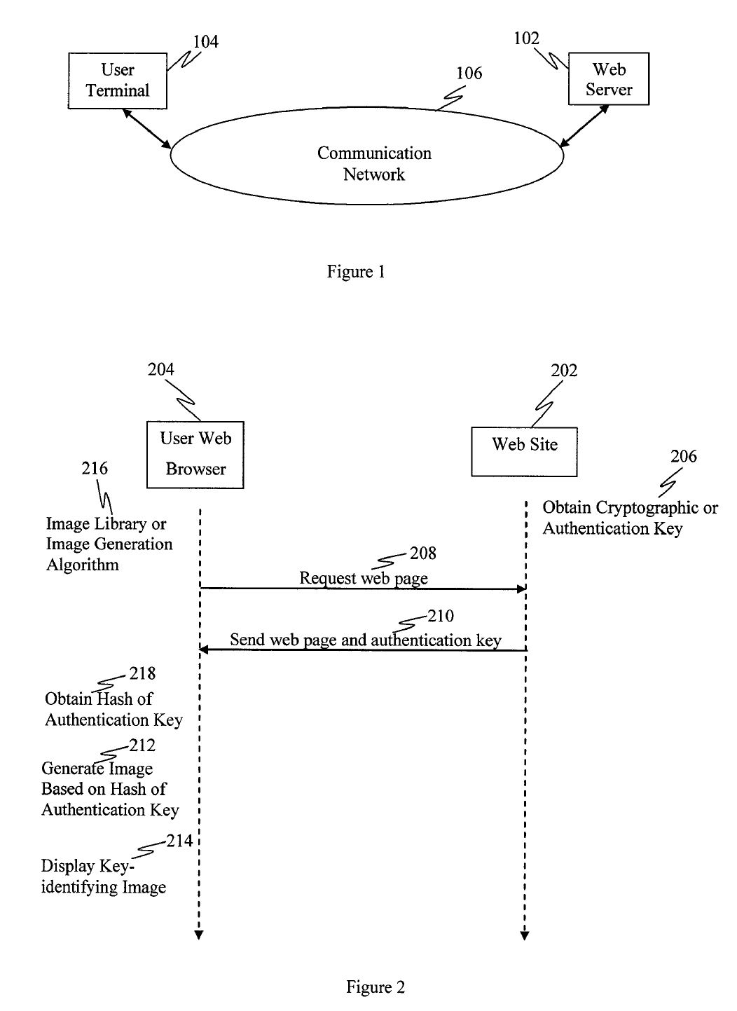

FIG. 1 illustrates a communication network in which a visual authentication scheme may be implemented. A web server 102 may provide web sites to a requesting user terminal 104 via a wired and/or wireless communication network 106, such as the internet. Web server 102 may be configured to host one or more websites (each website having one or more web pages) and provide them to a user terminal upon request. The user terminal 104 may execute a trusted application, such as a web browser or an email client. In this system, the web server delivers a web site/page along with an authentication/cryptographic key that the user terminal 104 which is configured to display an authentication or key-identifying image generated from the authentication/cryptographic key. However, the scheme illustrated in FIG. 1 is not limited to web servers and web pages. Generally, a host generates an electronic message (e.g., web page content, etc.) authenticated by an originator of the electronic message using a cryptographic key. The cryptographic key securely identifies the originator. The electronic message is then sent to a user terminal along with the cryptographic key. The host may also send an indication of the cryptographic key to use in rendering a key-identifying image at the user terminal.

A user at the receiving user terminal may visually authenticate the originator of the received electronic message by obtaining a key-identifying image based on the cryptographic key. The key-identifying image is displayed on the user terminal to enable the user to authenticate the originator of the electronic message. The key-identifying image is a function of the cryptographic key and is generated based on an image generation algorithm stored at the user terminal. The key-identifying image is selected from among a plurality of key-identifying images stored at the user terminal. The one or more images forming the key-identifying image that uniquely identifies the cryptographic key used by the originator to authenticate the electronic message. The key-identifying image that is displayed is selected based on at least one of (a) an indication sent by the message originator, (b) a preference stored at the user terminal, or (c) user actions. In some implementations, a collision-resistant function is used to generate the key-identifying image and inhibit generating the same image using other keys.

FIG. 2 illustrates an example of a visual authentication scheme that may operate on the communication network of FIG. 1. A web site 202 may obtain a cryptographic/authentication key 206 from a third party authority, such as Verisign, or generate its own cryptographic/authentication key. A user web browser 204 (operating on a user terminal) requests a web page 208 from web site 202 (from a host device or originator). The website 202 (operating on a web server) delivers the requested web page along with a cryptographic/authentication key 210 to the web browser 204. This authentication key 206 may be used by the user's web browser 204 in generating a key-identifying image 212 that is displayed to the user 214, thereby associating the generated image with the web site 202 (e.g., originator). In one implementation, the key-identifying image 212 is selected from a plurality of images 216 on the web browser 204 device (e.g., user terminal) or generated using an image generation algorithm on the web browser 204. Additionally, to provide greater security, a hash 218 of the authentication key 206 may be used to obtain the key-identifying image 212. The key-identifying image is displayed prior to the user providing the sensitive information.

Because authentication keys are unique to each website, and different authentication keys generate different images, a user would be alerted to a pirated website even if it looked the same as a trusted website. That is, if a user were to enter a pirated website that looked like a trusted website, the generated authentication image (which would be different than the authentication image of the trusted website) would alert the user that this is not the intended (trusted) website. Such authentication image is generated by the locally by the user's web browser so it is never sent over a communication channel (e.g., the internet) where it can be intercepted. Additionally, the image may be displayed to the user upon entering a new website page. This allows the user to visually verity the authenticity of the website prior to entering any personal or confidential information, such as an account number, password, username, etc.

Signed certificates, as may be obtained from middlemen such as Verisign, certify that a particular URL belongs to the sender. While these signed certificates are used between computers and/or applications, they typically do not alert the user as to the identity of the source (e.g., sender or owner) of a web page.

### User Terminal

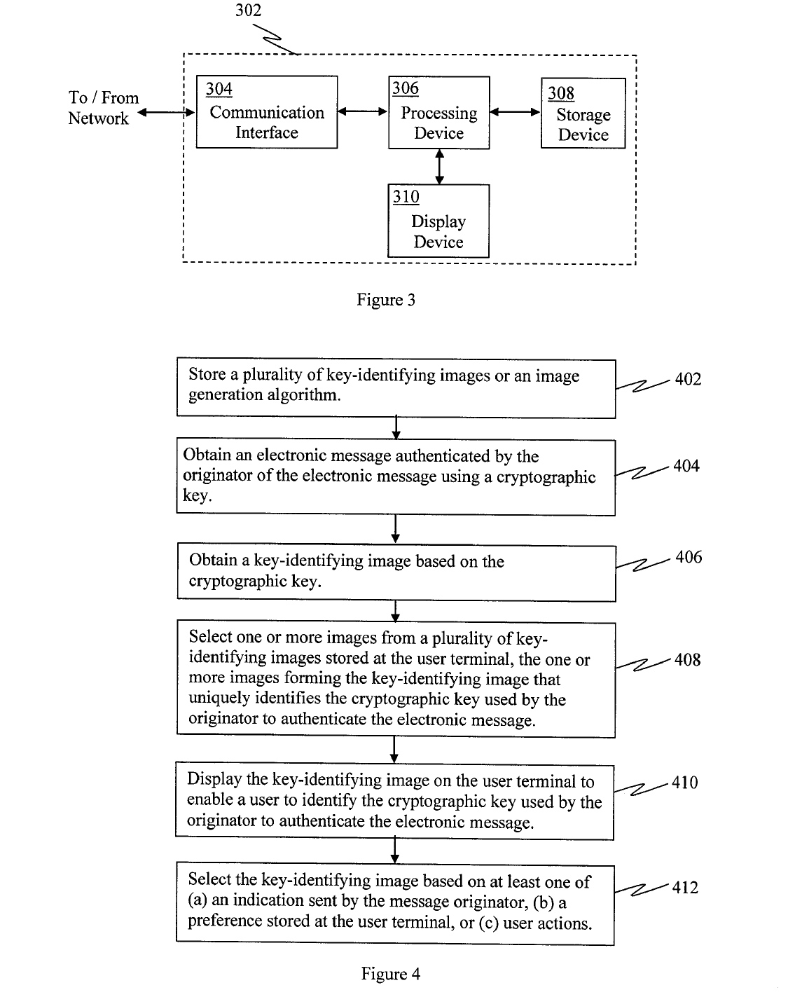

FIG. 3 illustrates one example of a user terminal that may be configured to provide a user with visual authentication of a displayed website's owner. The user terminal 302 includes a communication interface 304 to couple to a communication network (e.g., the internet) and permit the terminal 302 to send and receive information. A processing device 306 allows the terminal 302 to request a webpage via the communication interface 304, process the received webpage, and displays it to the user through a display device 310. A storage device 308 may store one or more images that can be used for a visual authentication scheme.

FIG. 4 illustrates a method that may operate on the user terminal 302 to enable the user to visually authenticate an originator (e.g., source, sender or owner) of a received electronic message (e.g., web page or web site). The user terminal may store a plurality of key-identifying images or an image generation algorithm 402. The user terminal obtains an electronic message authenticated by the originator of the electronic message using a cryptographic key 404. Along with the electronic message, the user terminal may receive the cryptographic key. The cryptographic key securely or uniquely identifies the originator (e.g., owner or sender) of the electronic message. A key-identifying image is obtained based on the cryptographic key 406. One or more images may be selected from a plurality of key-identifying images stored at the user terminal, the one or more images forming the key-identifying image that uniquely identifies the cryptographic key used by the originator to authenticate the electronic message 408. For example, a hash based on the authentication key may be used to select or generate the key-identifying image. For instance, the hash may be used to select an image from the plurality of images stored in the user terminal. The hash or image generating algorithm may be a collision-resistant function that prevents or inhibits generating the same key-identifying image using other keys. The key-identifying image is displayed on the user terminal to enable a user to identify the cryptographic key used by the originator to authenticate the electronic message 410. That is, the user may associate this key-identifying image with the originator's (e.g., webpage sender) identity so that the user can easily determine the identity of the sender just by glancing at the key-identifying image. This permits the user to visually verify that the expected sender of a webpage sent the webpage and not a pirate. The key-identifying image may be selected based on at least one of (a) an indication sent by the message originator, (b) a preference stored at the user terminal, or (c) user actions 412.

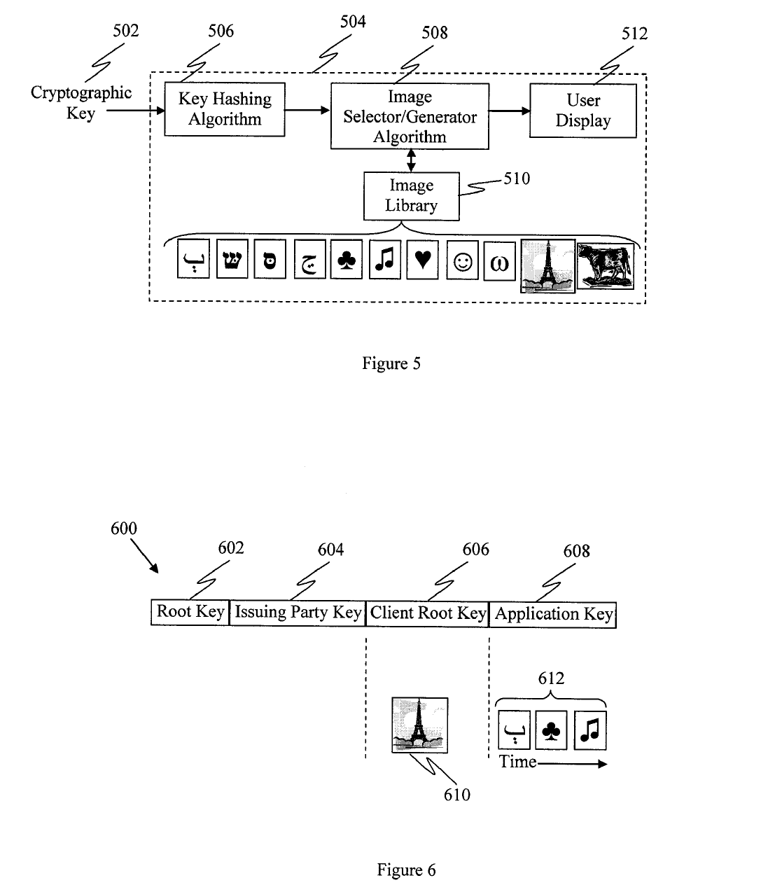

FIG. 5 illustrates application components operational on a user terminal that enable the user to visually authenticate a source (e.g., sender or owner) of a received website. A cryptographic key 502 is received (from an external source) by the user terminal 504 along with a web page. A key hashing algorithm 506 (e.g., one-way function, collision-resistant function, etc.) is used to obtain a hash of the cryptographic key 502. The hash is then used to select an image from an image library 510 including pre-stored images, icons, and/or visual representations stored in the user terminal 504. The selected image is sent to a user display 512 so that the user may associate the image with the source (e.g., owner or sender) of the particular web page.

To increase security, the key hashing algorithm 506 and/or image selection/generation algorithm 508 are not transmitted to the user terminal 504 with the cryptographic key 502. Instead, they may be obtained by the user terminal 504 independently from the cryptographic key or be part of the software installed on the user terminal 504. The hashing algorithm 506 and image selection/generation algorithm 508 are used to prevent hacking of the cryptographic key 502 based on the key-identifying images displayed to the user. These algorithms cause the selected or generated key-identifying image to be sufficiently unique that no two cryptographic keys are likely to have the same key-identifying image.

### Generation of Key-Identifying Images

Images that serve as visual authentications of a sender's identity (i.e., key-identifying images) may be obtained in various ways. Preferably, the image is not sent by a website (originator) to the web browser (user terminal) in real-time, thereby avoiding the risk of having someone capture the image during transmission. Instead, the key-identifying image may be generated or stored on a user's terminal from where it is chosen based on the website cryptographic key. Alternatively, the cryptographic key may be used to generate an image using an image-generation algorithm (e.g., a fractal generation algorithm, etc.).

In one example, a key-identifying image may be selected from a plurality of images stored at a user's terminal. Such images may be icons or hieroglyphs (in grayscale or color) that are part of the user's browser, an independent library, and/or setup by the sending website through an independent setup operation.

In another example, a fractal algorithm residing at a user's terminal uses a website's unique authentication/cryptographic key (or a derivation thereof) to generate a key-identifying image or icon unique to the website.

One level of security may be added to this scheme by using an algorithm on the user terminal to processes the received cryptographic key from a host (e.g., originator or website) and obtain a hash or derivative key which can then be used to select or generate a key-identifying image. By utilizing a derivative key rather than the actual received cryptographic key, it makes it more difficult for a hacker to determine the image generation or selection algorithm from a sample of selected images and/or cryptographic keys.

Yet another feature enables a webpage source (e.g., sender or owner) to define which part(s) or segment(s) of a transmitted cryptographic key should be used by a receiving user's terminal to generate a key-identifying image.

### Cryptographic Key Hierarchy

FIG. 6 illustrates how a cryptographic key may include a hierarchy of keys. In this example, the cryptographic key may include a plurality of certificates, such as a Root Key 602, an Issuing Party Key 604, a Client Root Key 606, and an Application Key 608. The Root Key 602 may serve to identify a type of authentication/cryptographic key while the Issuing Party Key 604 may identify the issuing party (e.g., a third party such Verisign, etc.). A Client Root Key 606 may serve to identify a particular website owner (e.g., Yahoo, MasterCard, Bank of America, EBay, etc.). The website owner may have control over the Application Key 608 so that it can assign different keys to its different online applications. Additionally, a website owner to change the Application Key, either periodically or as needed, to disable a compromised key or as a security mechanism.

In various implementations, an key-identifying image may be generated from the whole cryptographic key 600 or from one or more segments of the cryptographic key. For example, images may be generated from either the Client Root Key 606 or from the Application Key 608. Depending on the implementation, a website owner may determine the part/segment(s) of the cryptographic key used in generating the key-identifying image at the user terminal.

One scheme allows a website owner to change the Application Key 608 as needed or desired. However, if key-identifying images are generated based wholly or partially on the Application Key 608, this change would cause different key-identifying images 612 to be displayed at the user terminal. Such change in key-identifying images may hinder user recognition and/or association of a particular image with a website owner. Therefore, another key, such as a non-changing Client Root Key 606, may be used instead to generate the key-identifying image 610. In this manner, the same key-identifying image 610 would be displayed to the users even if other parts/segments of the cryptographic key 600 are changed.

Another feature may provide constraints that safeguard higher level keys. That is, the website owner may allow a user's terminal to display an image associated with Application Key 608 but prevent images associated with higher level keys 602, 604 and/or 606 from being displayed. Such security scheme would safeguard images generated from higher level keys.

Additionally, a particular website owner may control which key-identifying images are displayed based on class of user or user terminal. For example, when a user terminal requests a website from a web server, it provides its IP address to the web server. Based on the IP address, the website owner can then provide a different cryptographic key to the requesting user terminal or cause a different authentication image to be displayed at the user terminal. Alternatively, the website owner may provide the same cryptographic key but direct user terminals to use different parts of the cryptographic key to cause different key-identifying images to be displayed according to the class of users.

### User Activation of Visual Authentication

Another feature grants a terminal user the option of activating and deactivating the key-identifying images. That is, while a user is not allowed to select which image should be associated with a particular website or cryptographic key (this is controlled by the website owner), the user can control whether key-identifying image is displayed at all and certain parameters of the key-identifying image. For example, the user may select a particular library or type of images from which to select the key-identifying image. In another example, a user may optionally activate auditory authentication where a set of audible tones uniquely associated with the cryptographic key are generated.

### Authentication on a Wireless Phone

In one implementation, a caller or website's identity may be authenticated using key-identifying images or audio tones. For example, since the caller ID that is displayed on a phone may be spoofed, a key-identifying image or audio tone may be generated based on the caller's phone number or other highly secure number or code. The key-identifying image or tone may be selected from a collection of images or tones stored in the phone or it may be generated based on an algorithm stored phone. In this manner a phone user can authenticate a caller even if the caller ID is spoofed or otherwise modified.

### Host or Web Server Operation

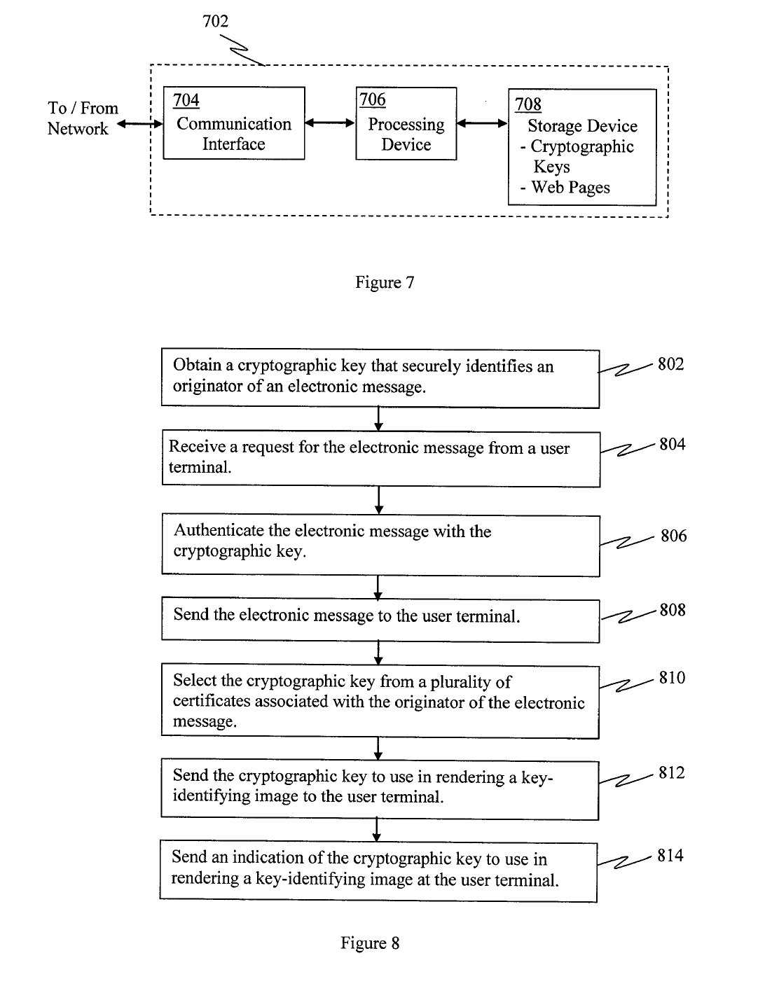

FIG. 7 illustrates a web server or host device configured to provide web pages with cryptographic keys to user terminals to facilitate visual authentication of the web pages at the user terminals. The web server 702 includes a communication interface 704 to couple to a network, such as the internet. Communication interface 704 is used to receive requests for web pages from user terminals coupled to the network. A processing device 706 processes a web page request by retrieving the requested web page from a storage unit 708 along with a corresponding cryptographic key. The cryptographic key may be generated by the web server 702 or obtained from a third party so that it is unique to the requested web page or to the web page's sender or owner.

The web server 702 may also be configured to indicate what part of the cryptographic key should be used by a receiving user terminal to obtain key-identifying image. For example, when providing the cryptographic key to the web server or owner of the requested web page indicate which part of the cryptographic key should be used in providing visual authentication to a user. This allows a web page owner or sender to modify part of the cryptographic key while keeping the key-identifying image displayed to a user the same (by using an unmodified part of the cryptographic key to generate the key-identifying image).

Additionally, the web server 702 may distinguish between different classes of users requesting a web page and provide different cryptographic keys depending on the class of a requesting user. This may be alternatively be accomplished by the web server 702 indicating that different parts of a cryptographic key should be used by different classes of users in generating key-identifying images. FIG. 8 illustrates a method operational on a web server or host device that facilitates visual authentication of the sender of web pages displayed on user terminals. A cryptographic key is obtained that securely or uniquely identifies a on originator of an electronic message (e.g., web page source) 802 (e.g., owner or sender). This cryptographic key may be generated by the web site owner or sender or obtained from a third party. A request for the electronic message is received from a user terminal 804. The electronic message is authenticated with the cryptographic key 806. The electronic message is sent to the requesting user terminal 808. The cryptographic key is selected from a plurality of certificates associated with the originator of the electronic message 810. The cryptographic key is sent to use in rendering a key-identifying image to the user terminal 812. The host device may also send an indication of the cryptographic key to use in rendering a key-identifying image at the user terminal 814.

One or more of the components, steps, and/or functions illustrated in FIGS. 1, 2, 3, 4, 5, 6, 7 and/or 8 may be rearranged and/or combined into a single component, step, or function or embodied in several components, steps, or functions without departing from the invention. Additional elements, components, steps, and/or functions may also be added without departing from the invention. The apparatus, devices, and/or components illustrated in FIGS. 3, 5, and/or 7 may be configured to perform one or more of the methods, features, or steps described in FIGS. 2, 4, 6 and/or 8.

Those of skill would further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

It should be noted that the foregoing methods and/or devices are merely examples and are not to be construed as limiting the invention.

The description of the examples is intended to be illustrative, and not to limit the scope of the claims. As such, the present teachings can be readily applied to other types of apparatuses and many alternatives, modifications, and variations will be apparent to those skilled in the art.

What is claimed is:

1. A method for visually authenticating an originator of a received electronic message on a user terminal, comprising:
obtaining an electronic message authenticated by the originator of the electronic message using a cryptographic key;
obtaining a key-identifying image based on the cryptographic key; and
displaying the key-identifying image on the user terminal to enable a user to identify the cryptographic key used by the originator to authenticate the electronic message.

2. The method of claim 1 wherein the key-identifying image is a function of the cryptographic key.

3. The method of claim 1 wherein the key-identifying image is generated by a collision-resistant algorithm.

4. The method of claim 1 further comprising:
requesting the electronic message from a host; and
displaying the electronic message along with the key-identifying image.

5. The method of claim 1, wherein obtaining the key-identifying image based on the cryptographic key includes
generating the key-identifying image based on an image generation algorithm stored at the user terminal.

6. The method of claim 1 wherein obtaining the key-identifying image based on the cryptographic key includes
selecting one or more images from a plurality of key-identifying images stored at the user terminal, the one or more images forming the key-identifying image that uniquely identifies the cryptographic key used by the originator to authenticate the electronic message.

7. The method of claim 1 wherein the cryptographic key securely identifies the originator of the electronic message.

8. The method of claim 1 wherein the cryptographic key is selected from a plurality of keys, each key associated with a different key-identifying image.

9. The method of claim 1 wherein the cryptographic key is associated with a plurality of key-identifying images.

10. The method of claim 9 wherein the key-identifying image that is displayed is selected based on at least one of (a) an indication sent by the message originator, (b) a preference stored at the user terminal, or (c) user actions.

11. The method of claim 1 wherein obtaining the key-identifying image based on the one or more keys includes
using a collision-resistant function to generate the key-identifying image, wherein the collision-resistant function inhibits generating the same key-identifying image using other keys.

12. A user terminal comprising:
a communication interface to couple the user terminal to a network;
a display device; and
a processing device coupled to the communication interface and display device, the processing device configured to
obtain an electronic message authenticated by an originator of the message using a cryptographic key;
obtain a key-identifying image based on the cryptographic key; and
display the key-identifying image on the display device to enable a user to visually authenticate the cryptographic key used by the originator to authenticate the received electronic message.

13. The user terminal of claim 12 further comprising:
a storage device coupled to the processing device, the storage device for storing a plurality of key-identifying images, wherein the key-identifying image is selected from one or more of the plurality of the stored key-identifying images.

14. The user terminal of claim 13 wherein the one or more key-identifying images forming the key-identifying image that uniquely identifies the cryptographic key used by the originator to authenticate the electronic message.

15. The user terminal of claim 12 wherein the cryptographic key securely identifies the originator of the electronic message.

16. The user terminal of claim 12 wherein the cryptographic key is selected from a plurality of keys, each key associated with a different key-identifying image.

17. The user terminal of claim 12 wherein the cryptographic key is associated with a plurality of key-identifying images.

18. The user terminal of claim 12 wherein the key-identifying image that is displayed is selected based on at least one of (a) an indication sent by the message originator, (b) a preference stored at the user terminal, or (c) user actions.

19. The user terminal of claim 12 wherein the processing unit is further configured to generate a set of audible tones uniquely associated with the cryptographic key.

20. The user terminal of claim 12 wherein the processing unit is further configured to generate the key-identifying image using a collision-resistant function that inhibits generating the same key-identifying image using other keys.

21. A terminal device comprising:
means for obtaining an electronic message authenticated by the originator of the message using a cryptographic key;
means for obtaining a key-identifying image based on the cryptographic key; and
means for presenting the key-identifying image to enable a user to visually authenticate the cryptographic key used by the originator to authenticate the received electronic message.

22. The terminal device of claim 21 further comprising:
means for requesting the electronic message from the originator; and
means for displaying the electronic message along with the key-identifying image.

23. The terminal device of claim 21 further comprising:
means for selecting one or more images from a plurality of key-identifying images stored at the terminal device, the one or more images forming the key-identifying image that uniquely identifies the cryptographic key used by the originator to authenticate the electronic message.

24. The terminal device of claim 21 further comprising:
means for generating the key-identifying image based on a collision-resistant image generation algorithm stored at the terminal device.

25. A machine-readable medium having one or more instructions for allowing a user to visually authenticate an originator of a received electronic message on a terminal, which when executed by a processor causes the processor to:
obtain an electronic message authenticated by the originator of the message using a cryptographic key;
obtain a key-identifying image based on the cryptographic key; and
display the key-identifying image on the terminal to enable a user to visually authenticate the cryptographic key used by the originator to authenticate the electronic message.

26. The machine-readable medium of claim 25 having one or more instructions which when executed by a processor causes the processor to further:
display the electronic message along with the key-identifying image.

27. The machine-readable medium of claim 25 having one or more instructions which when executed by a processor causes the processor to further:
store a plurality of key-identifying images in the terminal; and
select one or more images from the plurality of key-identifying images, the one or more images forming the key-identifying image that uniquely identifies the cryptographic key used by the originator to authenticate the electronic message.

28. The machine-readable medium of claim 25 wherein the cryptographic key securely identifies the originator of the electronic message.

29. The machine-readable medium of claim 25 having one or more instructions which when executed by a processor causes the processor to further:
generate the key-identifying image based on an image generation algorithm stored at the user terminal.

30. A processing device comprising:
a processing unit configured to
obtain an electronic message authenticated by the originator of the electronic message using a cryptographic key;
select one or more images from the plurality of key-identifying images, the one or more images forming a key-identifying image that uniquely identifies the cryptographic key used by the originator to authenticate the electronic message; and
cause the key-identifying image to be displayed to enable a user to visually authenticate the cryptographic key used by the originator to authenticate the electronic message.

31. The processing device of claim 30 wherein the processing unit is further configured to
select the key-identifying image based on at least one of (a) an indication sent by the message originator, (b) a preference stored at the user terminal, or (c) user actions.

32. A method for facilitating visual authentication of a transmitted electronic message, comprising:
obtaining a cryptographic key that securely identifies an originator of the electronic message; and
authenticating the electronic message with the cryptographic key.

33. The method of claim 32 further comprising:
sending the electronic message to a user terminal along with the cryptographic key.

34. The method of claim 32 further comprising:
sending an indication of the cryptographic key to use in rendering a key-identifying image at the user terminal.

35. The method of claim 32 wherein the cryptographic key includes one or more certificates associated with the originator of the electronic message.

36. The method of claim 32 further comprising:
sending the cryptographic key to the user terminal.

37. The method of claim 32 further comprising:
selecting the cryptographic key from a plurality of certificates associated with the originator of the electronic message.

38. A host device comprising:
a communication interface to couple the host device to a network and receive a request for an electronic message from a requesting user terminal; and
a processing device coupled to the communication interface, the processing device configured to
obtain a cryptographic key that securely identifies an originator of the electronic message;
authenticate the electronic message with the cryptographic key; and
send an indication of the cryptographic key to use in rendering a key-identifying image at the user terminal.

39. The host device of claim 38 wherein the processing device is further configured to send the electronic message to a user terminal along with the cryptographic key.

40. The host device of claim 38 wherein the processing device is further configured to send an indication of one or more key-identifying images to render at the user terminal.

41. The host device of claim 38 wherein the cryptographic key is selected from a plurality of keys, each key associated with a different key-identifying image.

42. The host device of claim 41 wherein the cryptographic key is associated with a plurality of images that makeup the key-identifying image.

43. A server device comprising:
means for receiving a request for an electronic message from a requesting user terminal;
means for obtaining a cryptographic key that securely identifies an originator of the electronic message;
means for authenticating the electronic message with the cryptographic key; and
means for sending the electronic message to a user terminal along with the cryptographic key.

44. The server device of claim 43 further comprising:
means for indicating the cryptographic key to use in rendering a key-identifying image at the user terminal.

45. The server device of claim 43 wherein the cryptographic key includes one or more certificates associated with the originator of the electronic message.

46. A machine-readable medium having one or more instructions for facilitating visual authentication of a transmitted electronic message, which when executed by a processor causes the processor to:
obtain a cryptographic key that securely identifies an originator of the electronic message; and
send the electronic message to a user terminal along with the cryptographic key.

47. The machine-readable medium of claim 46 having one or more instructions which when executed by a processor causes the processor to further:
send an indication of one of the cryptographic key to use in rendering a key-identifying image at the user terminal.

48. The machine-readable medium of claim 46 having one or more instructions which when executed by a processor causes the processor to further:
authenticate the electronic message with the cryptographic key.

49. The machine-readable medium of claim 46 wherein the cryptographic key includes one or more hierarchical certificates associated with the originator of the electronic message.

50. A processing device comprising:
a processing unit configured to
obtain a cryptographic key that securely identifies an originator of the electronic message;
authenticate the electronic message with the cryptographic key; and
send an indication of the cryptographic key to use in rendering a key-identifying image at the user terminal.

51. The processing device of claim 50 wherein the processing unit is further configured to
send the electronic message to a user terminal along with the cryptographic key.
